(19) United States
(12) Patent Application Publication
(10) Pub. No.: US 2014/0371641 A1
(43) Pub. Date: Dec. 18, 2014

(54) FOOT MASSAGER FOR MASSAGING FEET

(71) Applicant: Andre Vlaeminck, Nevele - Herendree (BE)

(72) Inventor: Andre Vlaeminck, Nevele - Herendree (BE)

(73) Assignee: MARTINE VLAEMINCK, Landegem (BE)

(21) Appl. No.: 14/360,399

(22) PCT Filed: Nov. 23, 2011
(86) PCT No.: PCT/EP2011/070858

§ 371 Date: Aug. 26, 2014

(51) Int. Cl. A61H 15/00

(52) U.S. Cl. CPC A61H 15/0078
USPC 601/104

(57) ABSTRACT

A foot massager comprising a motor and a human foot receiver holding assembly comprising at least one human foot receiver for constraining at least one foot therein wherein the motor is provided for driving the human foot receivers such as to massage feet in the human foot receivers holding assembly, characterised in that the foot massager is provided with an eccentric block such that the motor, the eccentric block, the human foot receiver holding assembly and the human foot receiver are interconnected such that when driven by the motor the human foot receiver describes an elliptical translational movement such that the rotation axis of the elliptical translational movement intersects with the longitudinal direction of said human foot receiver.

This invention relates to a foot massager according to the first claim.

Foot massagers are already well known in the art. A foot massager is any device used to massage the feet of a person, through the use of vibration, rotating rollers, heat, or water. Massaging the feet can relieve stress, and can even have therapeutic effects. There are many different types of foot massagers available. A popular type of foot massager is an electric-powered one that features vibration, large rollers, heat, or a combination of those. These come in all different types of designs; some are positioned on the floor, and the user just puts one or both feet on top of it so it can massage the bottom of the feet. Others are shaped like slippers, to massage the top and sides of the feet while keeping them warm. In another design, the foot massager is shaped like a pair of boots, which is then capable of massaging the ankles and legs as well as the whole foot.

An example of an electric-powered foot massager is shown in U.S. Pat. No. 6,258,048. U.S. Pat. No. 6,258,048 describes a foot massager comprising, a motor and a slipper holding assembly comprising two slippers for constraining feet therein. The two slippers are positioned on a slipper mount wherein the motor is used for driving the slippers such as to massage feet in the slipper holding assembly. A vibrating mechanism and a roller assembly is driven by the motor, including a plurality of rollers mounted on the slipper mount are used for massaging a foot within the slipper.

Although such foot massager increases the blood flow in the feet, the blood flow in the feet is still considered insufficient for some applications.

There is thus a need for a foot massager which can increase the blood flow in feet of a patient.

Thereto, the rotation axis of the elliptical translational movement intersects with the longitudinal direction of said human foot receivers such that a foot constrained by the human foot receiver is driven in up and down movement by the elliptical translational movement of the human foot receiver and the elliptical translational movement is a vibrating movement with a frequency between 35 and 50 Hz.

The inventor has found that a foot massager provided with human foot receivers describing an elliptical translational movement such that the rotation axis of the elliptical translational motion intersects with the longitudinal direction of said human foot receivers such that a foot constrained by the human foot receiver is driven in up and down movement by the elliptical translational movement of the human foot receiver and the elliptical translational movement is a vibrating movement with a frequency between 35 and 50 Hz, increases the blood saturation in the user's feet, constrained by the human foot receivers. This increased blood saturation in the user's feet may avoid amputation of for instance toes with persons suffering from diabetes. The inventors believe that the elliptical translational vibrating motion with a frequency between 35 and 50 Hz of the human foot receiver receiving a bare foot or a foot wearing foot gear, stimulates the veins and the muscles of the lower leg, resulting in an improved perfusion of the soft hypodermic tissue of the feet, especially of those parts affected by vascular problems, for instance related to diabetes. Preferably, the human foot receiver holding assembly comprises two foot receivers. The frequency of the translational elliptical motion ranges from 35 to 50 Hz. Below this frequency, the increase of the perfusion of the soft hypodermic tissue of the feet is not sufficiently large to yield clear beneficial effects for a sufficiently large test group of people suffering from vascular pedal problems, while at frequencies above 50 Hz, the vibrating motion is uncomfortable and/or in some case painful for the users. This frequency range lies well within the operational capabilities of the motors that are suitable for this particular application. The up and down movement by the elliptical translational motion lies substantially in the plane, defined by the upper and the lower leg of the user.

According to preferred embodiments of the foot massager according to the invention, the foot receiver slopes with respect to the horizontal.

According to preferred embodiments of the foot massager according to the invention, the foot receiver slopes at an angle substantially equal to 45 degrees with respect to the horizontal.

This particular position of the foot receiver is both comfortable for the user of the foot massager and allows for an orientation of the lower leg and the feet constrained in the foot receiver which gives a particularly marked improved perfusion of the feet.

According to preferred embodiments of the foot massager according to the invention the foot receiver comprises straps for constraining at least one foot of a patient therein. Using straps makes it possible to quickly and easily constrain the feet of the user, regardless the size and shape of the feet, wearing shoes or not, such that the feet follow the elliptical translational vibrating movement of the foot receiver.

According to preferred embodiments of the foot massager according to the invention, the major diameter of the elliptical movement is between 4 and 50 mm and preferably 10 mm and the minor diameter between 1 and 25 mm, and preferably 5 mm. The inventors have found that this particular range is especially suited for the purpose of improving the perfusion of the soft tissue of the feet. The major diameter extends in a generally vertical direction and the minor diameter extends in a generally horizontal direction, substantially parallel to the feet of the user.

According to preferred embodiments of the foot massager according to the invention, the human foot receivers holding assembly comprises a rigid rod, extending substantially upwardly from the eccentric block. The rigid rod, connected to the eccentric block, offers a practical solution for the transmission of the elliptical translational movement from the motor to the human foot receivers. The rigid rod offers a basic way to articulate this transmission.

According to more preferred embodiments of the foot massager according to the invention a rigid frame is rigidly mounted on the rod. The presence of a rigid frame, rigidly mounted on the rod, offers a convenient intermediate structure for transmitting elliptical translational movement from the motor to the human foot receivers thanks to the rigid mounting and can be easily adapted to accommodate the human foot receivers.

According to preferred embodiments of the foot massager according to the invention, the rigid frame extends substantially horizontally from the rigid rod and encloses a sharp angle with the rod. This particular embodiment allows for a comfortable use of the foot massager, in which a person sits on a chair or bench in front of the foot massager and places his feet in the human foot receivers, connected to the frame, enclosing a sharp angle with the rod in order to increase the user-friendliness.

According to more preferred embodiments of the foot massager according to the invention a counterweight, extending downwardly from the frame is connected to the frame. The counterweight has a stabilising function, especially when a person, sitting on a chair or bench in front of the foot massager and places his feet in the human foot receivers, shifts a substantial part of the weight of his lower body onto the foot massager. To ensure the stability of the foot massager under these circumstances, a counterweight is provided.

According to a more preferred embodiment of the foot massager according to the invention means for connecting human foot receivers onto are extending upwardly from the frame and substantially parallel to the rod. This particular embodiment allows for a particularly attractive implementation of the foot massager, taking advantage of the favourable arrangement of the frame, enclosing a sharp angle with the rod in order to increase the user-friendliness, to which the means for connecting human foot receivers are connected. It also offers a practical platform to connect human foot receivers onto and can be formed to correspond in size and shape to a pair of human foot receivers.

The invention also relates to an assembly of the foot massager according to the invention and a chair, characterized in that the chair is arranged such that a user of the foot massager can constrain at least one foot in the human foot receiver when sitting on the chair.

Other details and advantages of the foot massager according to the invention will become apparent from the enclosed figures and description of preferred embodiments of the invention.

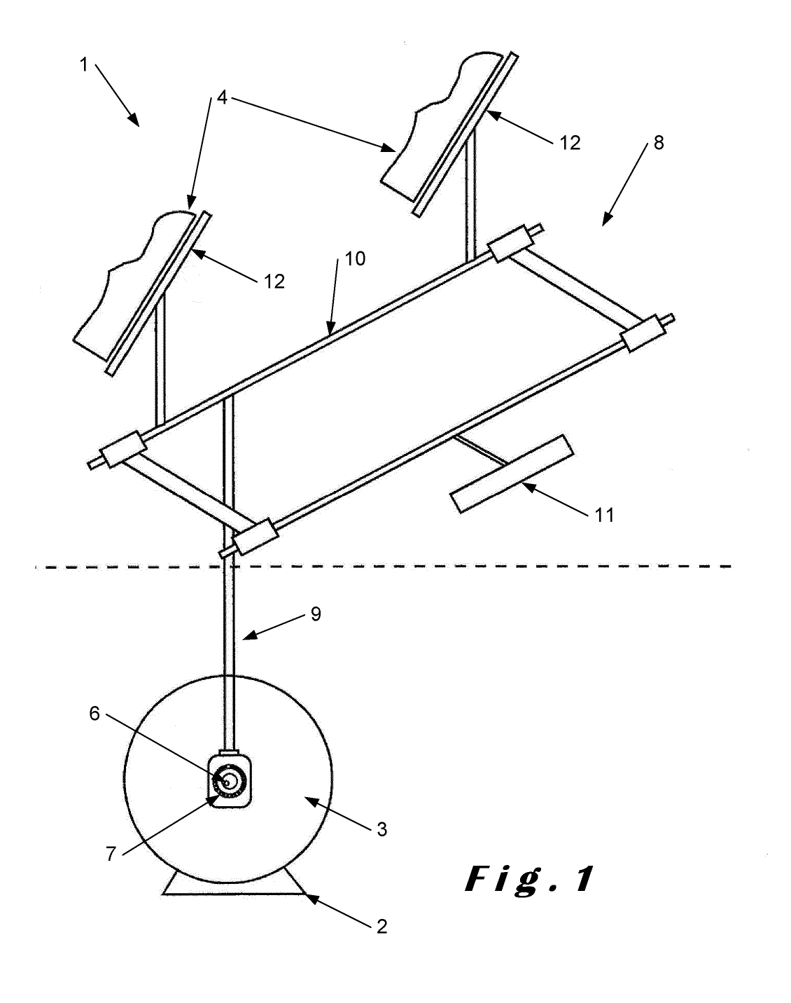

FIG. 1 shows a foot massager according to the invention.

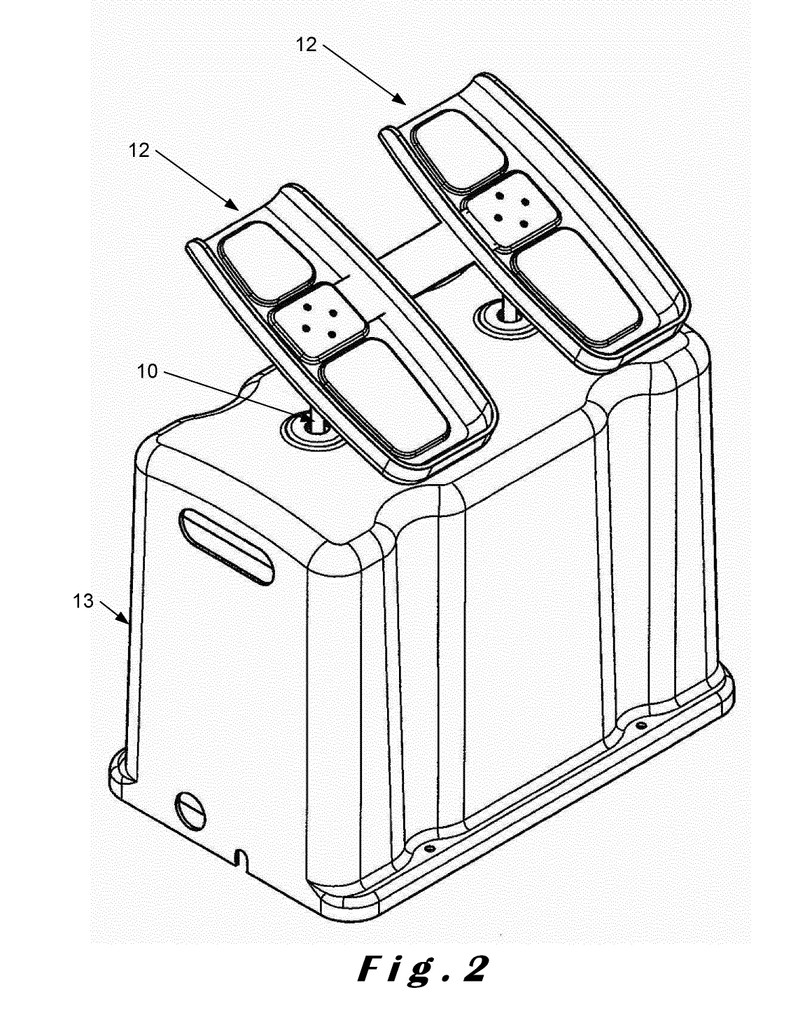

FIG. 2 shows a different embodiment of the foot massager according to the invention.

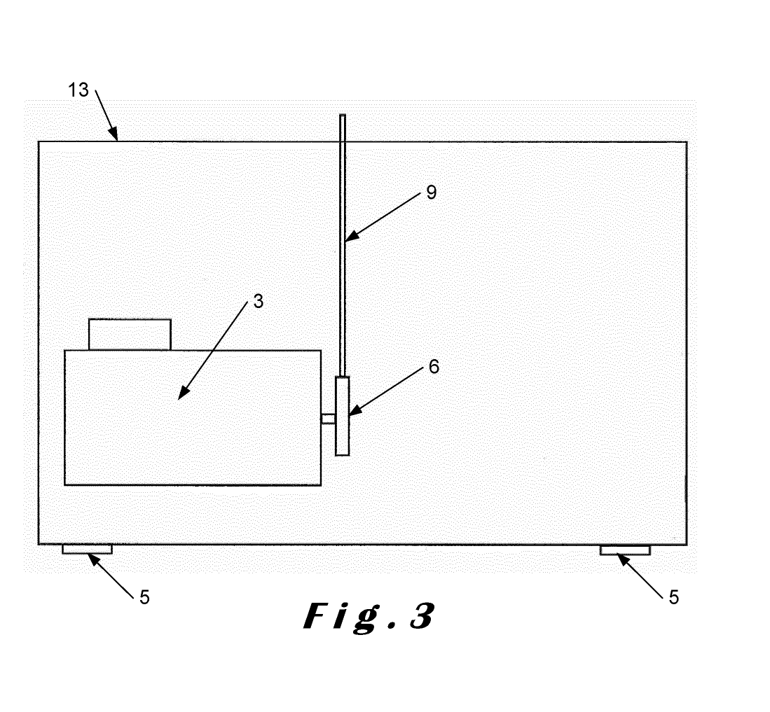

FIG. 3 shows a preferred embodiment of a foot massager according to the invention.

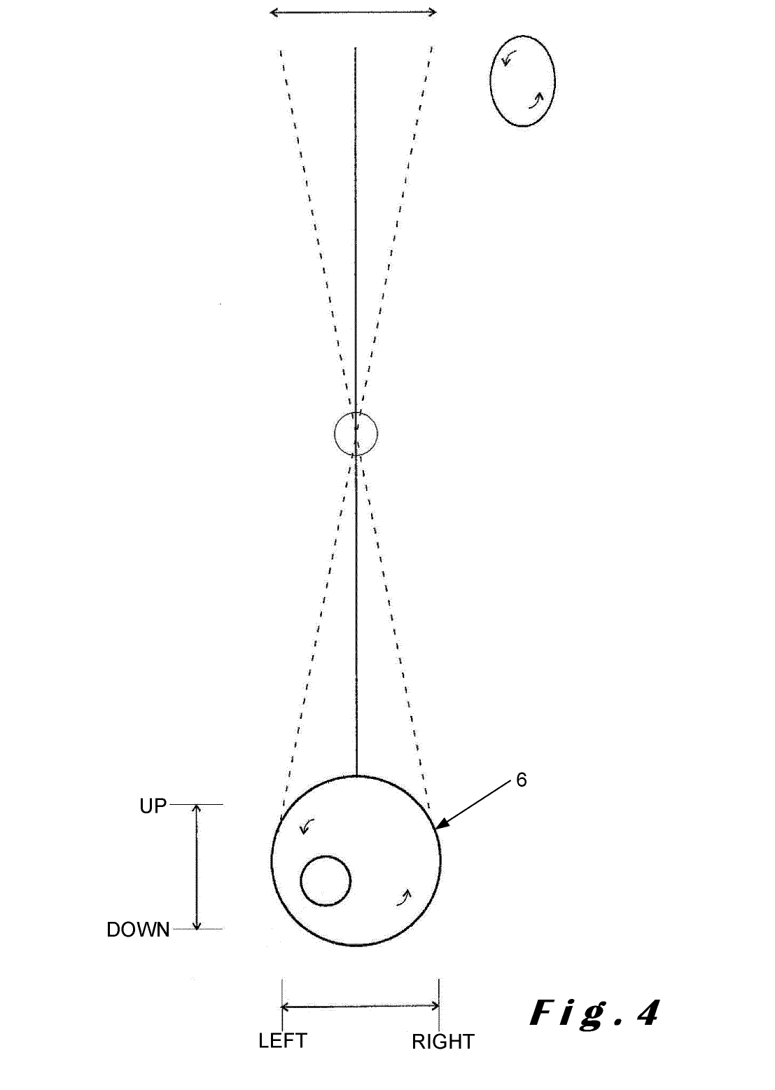

FIG. 4 shows a more detailed view of the eccentric block in operation in a preferred embodiment of a foot massager according to the invention.

With reference to FIGS. 1 to 4, the new foot massager, embodying the principles and concepts of the present invention and generally designated by reference numeral 1 will be described.

The present invention, designated as numeral 1, includes in one embodiment a base plate 2, preferably having a rectangular configuration, on which the motor 3 is mounted. The base plate 2 is made from a resilient material, for example but not limited to stainless steel, any other metal or alloy or a composite material. The thickness of the base plate is chosen depending on the material, for example a stainless steel base plate with a thickness between 2 and 10 mm is suitable for this particular application. The dimensions of the base plate are preferably chosen to correspond more or less to the dimensions of the two human foot receivers 4 for constraining feet, for example, ranging from 200 to 400 mm by 200 to 400 mm. Preferably, four holes are drilled in the four corners of the base plate 2, said base plate 2 preferably having a rectangular configuration, wherein four shock absorbers 5 can be mounted. The shock absorbers 5 can be made of any material known to absorb vibrations, for example, but not limited to plastics, rubbers and cork. Depending on the material chosen the shock absorbers 5 have a height of 15-40 mm and a diameter of 2-15 mm. In use, the shock absorbers 5 improve the absorption of the vibrations, generated by the motor 3. The motor 3 is mounted on the base plate 2 trough connecting means. The connecting means are preferably one of rivets, nuts and bolts or any means found suitable by the person skilled in the art.

The motor 3, driving the foot massager 1, mounted on the base plate 2, is preferably an electric motor 3. The electric motor 3 includes a motor shaft, rotatable around the motor axis, and a control assembly, further including a digital frequency controller for controlling the driving frequency and is provided to generate a rotational motion. The control assembly can be controlled by a plurality of switches. Optionally the control assembly can be controlled by a remote control. An electrical cord is preferably provided to connect the motor to a power source. The cord is provided to be plugged into any socket. The motor is provided to receive a plurality of power source voltages. The electrical power can be provided through the power grid or through one or more batteries or fuel cells, especially when portable foot massagers are considered.

An eccentric block 6 is mounted on the motor shaft in such a way that it enables an elliptical translational motion of the human foot receivers such that the rotation axis of the elliptical translational motion intersects with the longitudinal direction of the human foot receivers. The motion generated by the motor is transmitted by the eccentric block to the human foot receivers holding assembly 8 and eventually to the human foot receivers. The eccentric block 6 can be made from any hard material, preferentially from a metal, alloy or composite material, for example aluminium or an aluminium alloy.

The human foot receivers holding assembly and the eccentric block are connected by connecting means 7. The connecting means 7 are for example vibration-free ball bearings. The human foot receivers holding assembly 8 comprises in a preferential embodiment a rigid rod 9 extending in a substantially upward direction from the eccentric block 6. Rigidly mounted on the rod 9 there is a rigid frame 10, extending substantially horizontally from the rigid rod 9 and enclosing a sharp angle with the rod, connected to the frame a counterweight 11, extending downward from the frame and extending upward from the frame and substantially parallel to the rod, means for connecting human foot receivers onto. The rod 9 and the frame 10 made from any material providing enough strength and rigidity to the human foot receivers holding assembly 8 to sustain the weight of lower part of the body of an adult person, but preferably from a metal, an alloy or composite material. The rod 9 and frame 10 may be made from the same material or a different material. The frame 10 is for example built up from a plurality of rigid rods, forming for example a quadrangle, with an upper part, a lower part, a left part and a right part. The counterweight 11, extending downward from the lower part of the frame 10 can be made from any heavy material, such as stainless steel. The connections between the rod 9 and the frame 10 and between the frame 10 and the counterweight 11 can be a welding, an assembly of nuts and bolts, or any other connection known to the person skilled in the art. Said connections can be the same or different. The means for connecting human foot receivers 4 to the frame are for example two rigid rods extending upward from the upper part of the frame which are rigidly connected to a platform 12 for connecting one human foot receivers 4 to each rod, tilted in such a way that a person, seated in a chair in front of the foot massager can comfortably insert his/her feet in the human foot receivers 4, connected to the platform. Alternative means for connecting human foot receivers to the frame 10 known to the person skilled in the art can equally well be considered.

The human foot receivers 4 are provided to receive a foot of a human, a bare foot as well as a foot wearing footgear. Footgear comprises for example shoes, sandals, etc. The human feet receivers 4 can receive the foot of a human by means of any kind of connector, for example straps for example provided with hook-and-loop fasteners, or other means such as buttons etc.

As shown in FIGS. 2 and 3, the foot massager according to one embodiment of the present invention comprises a housing 13, in the shape of a box, mounted on the base plate 2 and covering the motor 3 and at least part of the human foot receivers holding assembly 8 but leaving at least the means for connecting human foot receivers 4 to the frame 10 and the human foot receivers 4 exposed. The housing 13 can be made from any suitable material, preferably from a composite material. Ventilation holes for cooling the motor 3 and recesses to be used as handles are preferably present in the housing 13. Further openings for reading and/or adjusting the frequency and for the electric cord are present in preferential embodiments.

In operation, the motor 3 drives the motor shaft and the eccentric block 6 mounted on the motor shaft. The eccentric block 6 rotates around the motor axis and moves the rigid rod 9, connected to the eccentric block 6 by means of ball bearings 7, up and down and from the left to the right in an elliptical translational movement, as illustrated in FIG. 4. The rigid connection with the frame 10 transmits the elliptical translational movement to the platforms 12 for connecting the human foot receivers and finally to the human foot receivers 4.

### EXAMPLE

An electric motor powered foot massager is used for massaging feet. An asynchronic motor 3F with a power of 0.18 Kw is mounted on a base plate mounted in turn on shock absorbers. The base plate is a 6 mm thick stainless steel plate, with dimensions of 330×200 mm. The shock absorbers are mounted in 4 different 7 mm deep holes drilled in the corners of the base plate, with a height of 25 mm and a diameter of 6 mm. The motor is controlled using a digital frequency controller and is operated with a remote control. The power grid delivers a voltage of 230 V three-phase alternating current. A three meter long electrical cord provides current to the foot massager.

The frequency was set at 35 Hz, the intensity at 2.5 cm, along the Y-axis (i.e. up and down) and the feet of the patients were massaged for 10 min. The effect of the massage on the blood perfusion in the feet was measured using the oxygen to see (O2C) appliance from LEA Medizintechnik GmbH. The oxygen to see appliance uses white light spectroscopy and a laser-Doppler method with a probe which can measure the quantity of haemoglobin in a tissue at a depth of 2 and 8 mm. The effects of the foot massage have been measured for superficial (at a depth of 2 mm from the upper skin) and deep (at a depth of 8 mm from the upper skin) perfusion. Data has been collected from 6 different patients for the perfusion at four different locations on the foot: under the hallux (M1), under the dorsum of the foot (M2), at the Achilles tendon (M3) and under the heel (M4). The values recorded are not absolute numbers but refer to a change in terms of percentage of the perfusion due to the massage compared to the perfusion before the massage. The results of the measurements are collected in Table 1.

The results show an overall positive effect under the hallux and under the heel, especially a positive effect on the deep perfusion under the hallux is observed.

TABLE 1
relative change in terms of percentage in the perfusion of
the feet at for different locations on the foot and at two
different depths for six patients, see text for details

| | SUPERFICIAL | | | | DEEP | | | |
|---|---|---|---|---|---|---|---|---|
| | M1 | M2 | M3 | M4 | M1 | M2 | M3 | M4 |
| 1 | −21% | 52% | 160% | 43% | 116% | 8% | 33% | 27% |
| 2 | 646% | 209% | 130% | 46% | 247% | 145% | 43% | 42% |
| 3 | 29% | 84% | 105% | −26% | −14% | 43% | −8% | −14% |
| 4 | 48% | −4% | −47% | −24% | NA | 5% | −47% | −48% |
| 5 | −1% | −81% | −56% | 96% | 38% | −30% | −54% | −16% |
| 6 | 148% | 75% | 53% | 51% | 81% | 128% | −4% | 28% |

1. A foot massager comprising:
a motor and
a human foot receiver holding assembly comprising at least one human foot receiver for constraining at least one foot of a patient therein;
wherein the motor is provided for driving the human foot receivers such as to massage feet in the human foot receivers holding assembly, the foot massager is provided with an eccentric block such that the motor, the eccentric block, the human foot receiver holding assembly and the human foot receiver are interconnected such that when driven by the motor the human foot receiver describes an elliptical translational movement, characterized in that the rotation axis of the elliptical translational movement intersects with the longitudinal direction of said human foot receivers such that a foot constrained by the human foot receiver is driven in an up and down movement by the elliptical translational movement of the human foot receiver and the elliptical translational movement is a vibrating movement with a frequency between 35 and 50 Hz.

2. The foot massager according to claim 1 is characterised in that the foot receiver slopes with respect to the horizontal.

3. The foot massager according to claim 2 is characterised in that the foot receiver slopes at an angle substantially equal to 45 degrees with respect to the horizontal.

4. The foot massager according to claim 1 is characterised in that the foot receiver comprises straps for constraining at least one foot of a patient therein.

5. The foot massager according to claim 1 is characterised in that the major diameter of the elliptical translational movement is between 4 and 50 mm and the minor diameter between 1 and 25 mm.

6. The foot massager according to claim 1 is characterised in that the human foot receivers holding assembly comprises a rigid rod, extending substantially upwardly from the eccentric block.

7. The foot massager according to claim 6 is characterised in that a rigid frame is rigidly mounted on the rod.

8. The foot massager according to claim 6 is characterised in that the rigid frame extends substantially horizontally from the rigid rod and encloses a sharp angle with the rod.

9. The foot massager according to claim 6 is characterised in that a counterweight, extending downwardly from the frame is connected to the frame.

10. The foot massager according to claim 6 is characterised in that means for connecting human foot receivers onto are extending upwardly from the frame and substantially parallel to the rod.

11. Assembly of the foot massager according to claim 1 and a chair, characterized in that the chair is arranged such that a user of the foot massager can constrain at least one foot in the human foot receiver when sitting on the chair.
